(19) United States
(12) Patent Application Publication
(10) Pub. No.: US 2016/0042890 A1
(43) Pub. Date: Feb. 11, 2016

(54) KEY STRUCTURE AND KEYBOARD MODULE

(71) Applicant: SILITECH TECHNOLOGY CORP., New Taipei City (TW)

(72) Inventors: Yen-Chih Lin, Taipei City (TW); Long-Jyh Pan, New Taipei City (TW); Tse-Ping Kuan, New Taipei City (TW)

(21) Appl. No.: 14/746,858

(22) Filed: Jun. 23, 2015

(30) Foreign Application Priority Data
Aug. 6, 2014 (TW) 103213966

(51) Int. Cl. H01H 13/7065; H01H 13/83; H01H 13/02

(52) U.S. Cl. CPC H01H 13/7065; H01H 13/023; H01H 13/83; H01H 2219/048; H01H 2221/044; H01H 2219/062; H01H 2219/06

(57) ABSTRACT

A key structure includes a switch circuit, an elastic member and a press unit. The switch circuit includes a predetermined press area. The elastic member is disposed on the predetermined press area of the switch circuit. The press unit is disposed on the elastic member and includes a flexible membrane and a plate. A part of the flexible membrane forms a press zone corresponding to the plate, wherein a position of the press zone is corresponding to a position of the elastic member, and the plate is fixed with the press zone. As one corner of the press zone is pressed, a corner of the plate moves downward accordingly while an opposite corner of the plate is limited by the flexible membrane from moving upward, such that the whole plate and the whole press zone move downward together to press the elastic member uniformly and trigger the switch circuit.

### CROSS-REFERENCE TO RELATED APPLICATION

This application claims the priority benefit of Taiwan application serial no. 103213966, filed on Aug. 6, 2014. The entirety of the above-mentioned patent application is hereby incorporated by reference herein and made a part of this specification.

### BACKGROUND OF THE INVENTION

1. Field of the Invention

The invention generally relates to a key structure and a keyboard module, and particularly to those being much thinner and providing stable touch feedback when being pressed.

2. Description of Related Art

With the rapid and staggering progress of science and technologies, automatic apparatuses are introduced to business and family. For example, keyboards are widely used to such as computers or cash registers, wherein the host receives and executes commands inputted by people through keyboards. Being a commonly used item in our daily lives, criterions of keyboards such as aesthetic of appearance, touch feedback, sounds in operation, balance, etc., is getting higher, or even stricter.

However, users may not apply a force to the center of a key cap of a keyboard when they press the key cap, and thus the key cap will tilt and cannot be effectively operated, and the keyboard is likely to be damaged due to an abnormal operation. Therefore, keyboards are provided with scissors-structure (or called X-type key structure) disposed between the key cap and a base plate of a key to accomplish a stable movement when the key is pressed by a user. Nevertheless, the X-type key structure has drawbacks of high cost, consisting of considerable amount of components, and requiring complicated assembly process. Furthermore, the thickness of the X-type key structure or the keyboard module applying the same is hardly to be reduced.

### SUMMARY OF THE INVENTION

The present invention provides a key structure which is thinner and capable of providing stable touch feedback.

The present invention further provides a keyboard module having the aforementioned key structure.

As embodied and broadly described herein, a key structure includes a switch circuit, an elastic member and a press unit. The switch circuit includes a predetermined press area. The elastic member is disposed on the predetermined press area of the switch circuit. The press unit is disposed on the elastic member and includes a flexible membrane and a plate. A part of the flexible membrane forms a press zone corresponding to the plate, wherein a position of the press zone is corresponding to a position of the elastic member, and the plate is fixed with the press zone. As one corner of the press zone is pressed, a corner of the plate moves downward accordingly while an opposite corner of the plate is limited by the flexible membrane from moving upward, such that the whole plate and the whole press zone move downward together to press the elastic member uniformly and trigger the switch circuit.

In one embodiment of the invention, the plate is disposed on an inner surface of the press zone facing the elastic member.

In one embodiment of the invention, the plate is disposed on an outer surface of the press zone far away from the elastic member.

In one embodiment of the invention, the flexible membrane has a lumpy profile, and a distance between the press zone and the switch circuit is greater than a distance between a remaining part of the flexible membrane and the switch circuit.

In one embodiment of the invention, the key structure further comprises a frame disposed between the switch circuit and the flexible membrane, and having an opening, wherein the elastic member is located in the opening, and the frame is separated from the plate.

In one embodiment of the invention, the flexible membrane is flat, and a distance between the press zone and the switch circuit is equal to a height of the frame.

In one embodiment of the invention, the flexible membrane has a lumpy profile, and a distance between the press zone and the switch circuit is greater than a height of the frame.

In one embodiment of the invention, the key structure further comprises a decoration layer disposed on at least a part of the flexible membrane.

In one embodiment of the invention, the key structure further comprises a key cap covering the press zone.

In one embodiment of the invention, the flexible membrane is integrally formed with the plate.

In one embodiment of the invention, a width of the elastic member is gradually decreased along a direction from the plate toward the switch circuit.

In one embodiment of the invention, a width of the elastic member is gradually increased along a direction from the plate toward the switch circuit.

In one embodiment of the invention, the key structure further comprises a light emitting device, a light guiding layer and a reflective layer. The light guiding layer has a surface disposed at a side of the switch circuit and another surface disposed at a side of the light emitting device. The light guiding layer is disposed between the switch circuit and the reflective layer. A part of the press zone is light transmissive, and a light emitted from the light emitting device is adapted to pass through the light guiding layer and the switch circuit, and then outputted from the press zone.

In one embodiment of the invention, the switch circuit comprises a light transmissive conductive film or at least a through hole.

In one embodiment of the invention, the key structure further comprises a touch sensing unit disposed between the elastic member and the press unit.

As embodied and broadly described herein, a keyboard includes a switch circuit, elastic members and press units. The switch circuit includes multiple predetermined press areas. The elastic members are respectively disposed on the predetermined press areas of the switch circuit. The press units are respectively disposed on the elastic members, and the press units comprises a flexible membrane and multiple plates, wherein the flexible membrane comprises multiple press zones corresponding to the plates, positions of the press zones are respectively corresponding to positions of the elastic members, and the plates are respectively fixed with the press zones. When one corner of one of the press zones is pressed, a corner of the plate fixed with the press zone moves downward accordingly while an opposite corner of the plate is limited by the flexible membrane from moving upward, such that the whole plate and the whole press zone move downward together to press the corresponding elastic member uniformly and trigger the corresponding switch circuit.

In one embodiment of the invention, each of the plates is disposed on an inner surface of the corresponding press zone facing the elastic member.

In one embodiment of the invention, each of the plates is disposed on an outer surface of the corresponding press zone far away from the elastic member.

In one embodiment of the invention, the flexible membrane has a lumpy profile, and a distance between each of the press zones and the switch circuit is greater than a distance between a remaining part of the flexible membrane and the switch circuit.

In one embodiment of the invention, the keyboard module further comprises a frame disposed between the switch circuit and the flexible membrane, and having multiple openings, wherein the elastic members are respectively located in the opening, and the frame is separated from the plates.

In one embodiment of the invention, the flexible membrane is flat, and a distance between each of the press zones and the switch circuit is equal to a height of the frame.

In one embodiment of the invention, the flexible membrane has a lumpy profile, and a distance between each of the press zones and the switch circuit is greater than a height of the frame.

In one embodiment of the invention, the key structure further comprises a decoration layer disposed on at least a part of the flexible membrane.

In one embodiment of the invention, the keyboard module further comprises multiple key caps respectively covering the press zones.

In one embodiment of the invention, the flexible membrane is integrally formed with the plates.

In one embodiment of the invention, a width of each of the elastic members is gradually decreased along a direction from the corresponding plate toward the switch circuit.

In one embodiment of the invention, a width of each of the elastic members is gradually increased along a direction from the corresponding plate toward the switch circuit.

In one embodiment of the invention, the key structure further comprises a light emitting device, a light guiding layer and a reflective layer. The light guiding layer has a surface disposed at a side of the switch circuit and another surface disposed at a side of the light emitting device. The reflective layer is disposed between the switch circuit and the reflective layer, wherein a part of each of the press zones is light transmissive, and a light emitted from the light emitting device is adapted to pass through the light guiding layer and the switch circuit, and then outputted from the press zones.

In one embodiment of the invention, the switch circuit comprises a light transmissive conductive film or multiple through holes.

In one embodiment of the invention, the keyboard module further comprises multiple touch sensing units respectively disposed between the elastic members and the press units.

As to the above, the key structure and the keyboard module of the invention are provided by fixing the plate to the press zone of the flexible membrane. By which, when one corner of one of the press zones is pressed, a corner of the plate fixed with the press zone moves downward accordingly while an opposite corner of the plate is limited by the flexible membrane from moving upward. Instead, the opposite corner of the plate is moved downwardly by the reactive force from the flexible membrane, such that the whole plate and the whole press zone move downwardly together to press the elastic member uniformly and trigger the switch circuit. In other words, forsaking the conventional X-type key structure, the key structure and the keyboard module of the invention are provided by fixing the plate to the press zone of the flexible membrane to accomplish vertical movement in operation. Accordingly, the key structure and the keyboard module of the invention have not only simple structure and low cost, but also thinner thickness to meet the requirement of slimness.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial schematic view of a keyboard module according to one embodiment of the present invention.

FIG. 2 is a partial schematic view of a keyboard module according to another embodiment of the present invention.

FIG. 3 is a partial schematic view of a keyboard module according to another embodiment of the present invention.

FIG. 4 is a partial schematic view of a keyboard module according to another embodiment of the present invention.

FIG. 5 is a partial schematic view of a keyboard module according to another embodiment of the present invention.

FIG. 6 is a partial schematic view of a keyboard module according to another embodiment of the present invention.

FIG. 7 is a partial schematic view of a keyboard module according to another embodiment of the present invention.

FIG. 8 is a partial schematic view of a keyboard module according to another embodiment of the present invention.

FIG. 9 is a partial schematic view of a keyboard module according to another embodiment of the present invention.

FIG. 10 is a partial schematic view of a keyboard module according to another embodiment of the present invention.

FIG. 11 is a partial schematic view of a keyboard module according to another embodiment of the present invention.

### DESCRIPTION OF EMBODIMENTS

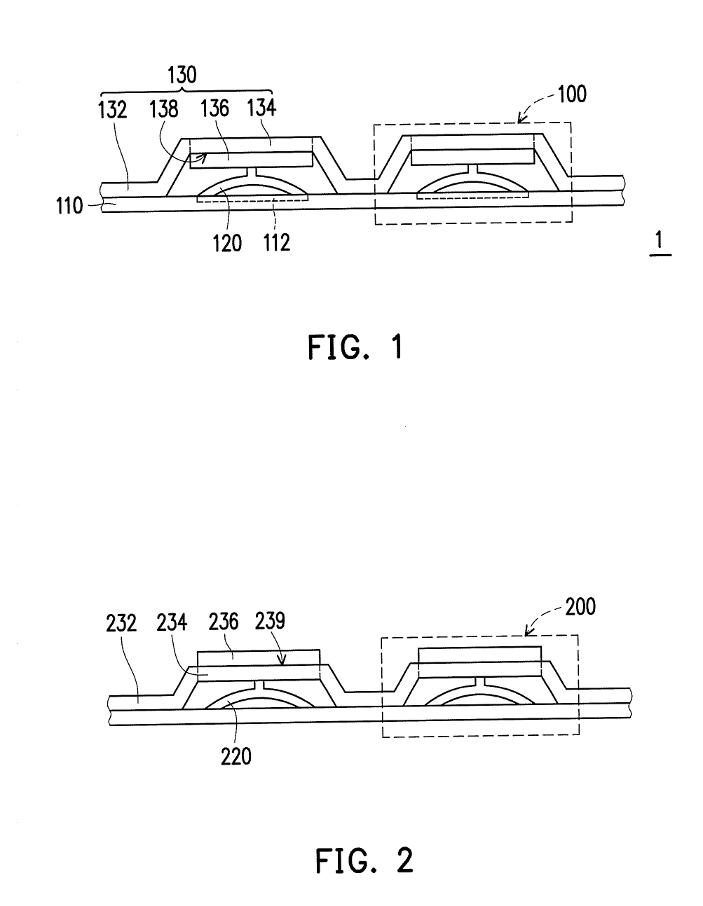

FIG. 1 is a partial schematic view of a keyboard module according to one embodiment of the present invention. As shown in FIG. 1, the keyboard module 1 includes multiple key structures 100 comprising a switch circuit 110, multiple elastic members 120 and multiple press units 130. The switch circuit 110 includes multiple predetermined press areas 112. FIG. 1 schematically shows two key structures 100 as an example, including two elastic members 120 and two press units 130, and the switch circuit 110 having two predetermined press areas 112 corresponding to the two elastic members 120; however, the number of the key structures of the keyboard module 1 is not limited thereto.

In the present embodiment, the switch circuit 110 may be membrane switch circuit. While in other embodiments, instead, the switch circuit 110 may be a flexible circuit board or a printed circuit board. Type of the switch circuit 110 is not limited in the present invention.

The elastic members 120 are respectively disposed on the predetermined press areas 112 of the switch circuit 110. The elastic members 120 may be metal domes, rubber domes, magnetic actuators or other actuators which are capable of providing touch feedback when sustaining pressure. In the present embodiment, each of the elastic members 120 is in cup-shape, and a width of the elastic member 120 is gradually increased along a direction from the press unit 130 toward the switch circuit 110; however, the shape and profile of the elastic members 120 are not limited thereto.

The press units 130 are respectively disposed on the elastic members 120 and include a flexible membrane 132 and multiple plates 136. The flexible membrane 132 has a lumpy profile which forms multiple press zones 134 in positions corresponding to the elastic members 120, and the plates 136 are respectively fixed with the press zones 134. Referring to FIG. 1, the flexible membrane 132 has two bumps, wherein a top of each of the bumps serves as the press zone 134, and each of the plates 136 is disposed on an inner surface 138 of the corresponding press zone 134 facing the elastic member 120 and contacts the elastic member 120. In the present embodiment, since the press zone 134 is foamed on the bump of the flexible membrane 132, a distance between the press zone 134 and the switch circuit 110 is greater than a distance between a remaining part (such as areas in the periphery of the press zone 134) of the flexible membrane 132 and the switch circuit 110, so as to provide a space for pressing the press unit 130 downward.

In the present embodiment, the flexible membrane 132 and the plate 136 are different members. For example, the flexible membrane 132 may be made of Thermoplastic polyurethanes (TPU). The plates 136 may be common plastic slices, which are made of Polypropylene (PP), for example. The material of the flexible membrane 132 is soft, the material of the plates 136 is much harder, and the flexible membrane 132 may be fixed to the plates 136 through adhesive. Certainly, material or fixing manner between the flexible membrane 132 and the plates 136 are not limited to those mentioned in the above. In other embodiments, the plates 136 may be connected to the flexible membrane 132 through adhesive bonding, hot melting, ultrasonic-wave bonding, etc., after fabricating the plates 136 and the flexible membrane 132 individually. Furthermore, the flexible membrane 132 and the plates 136 may further be integrally formed through In-Mold Decoration technique, or made from one composite material.

It is noted that the bonding force between the flexible membrane 132 and the plates 136 is enhanced as the adhesive bonding area there between becomes larger, and thus a user receives a harder touch feedback when pressing the press unit downward. On the contrary, the bonding force between the flexible membrane 132 and the plates 136 is decreased as the adhesive bonding area there between becomes smaller, and thus a user receives a softer touch feedback when pressing the press unit downward. That is, one may adjust size and position of the adhesive bonding area between the flexible membrane 132 and the plates 136, to provide more desirable touch feedback. In one embodiment, the adhesive bonding area is located at center of two opposite surfaces of each plate 136 and the press zone 134 of the flexible membrane 132; and, the periphery surrounding the two surfaces are leaned against but not bonded with each other. However, the position of the adhesive bonding area is not limited to this.

Furthermore, as shown in FIG. 1, in the present embodiment, a part of the flexible membrane 132 (i.e., the area between the two press units 130) is connected to the switch circuit 110. Similarly, the flexible membrane may be connected to the switch circuit 110 through various manners, such as adhesive bonding, hot melting, ultrasonic-wave bonding, etc. Furthermore, in the present embodiment, the flexible membrane 132 is provided without through holes; however, the flexible membrane 132 with through holes may be provided in other embodiments for adjusting the touch feedback of a user.

The key structure 100 of the keyboard module 1 of the present embodiment provides a better sensitivity to the input of a user. In other words, the switch circuit 110 can still be successfully triggered even though the user press merely a corner of the press zone 134 rather than the center of the press zone 134. More specifically, in the present embodiment, the plate 136 is fixed on the inner surface 138 of the press zone 134 of the flexible membrane 130, and thus, when one corner of one of the press zone 134 is pressed, a corresponding corner of the plate 136 moves downward accordingly while an opposite corner of the plate 136 tends to move upward. However, since the plate 136 is covered by the press zone 134 of the flexible membrane 132, the opposite corner of the plate 136 is limited by the flexible membrane 132 from moving upward; instead, the plate 136 is moved downwardly by the reactive force from the flexible membrane 132. Therefore, the whole plate 136 and the whole press zone 134 move downward together to press the elastic member 120 uniformly and trigger the switch circuit 110.

In other words, forsaking the conventional X-type key structure, the key structure 100 of the present embodiment is provided by fixing the plate 136 to the press zone 134 of the flexible membrane 132 to accomplish vertical movement in operation. Accordingly, not only the keyboard module 1 of the invention has simple structure and low cost, but also the key structure 100 and the keyboard module 1 have thinner thickness to meet the requirement of slimness.

FIG. 2 is a partial schematic view of a keyboard module according to another embodiment of the present invention. Referring to FIG. 2, main difference between the key structure 200 of FIG. 2 and the key structure 100 of FIG. 1 lies in that: the plate 136 of FIG. 1 is disposed on the inner surface 138 of the press zone 134 facing the elastic member 120. On the contrary, in FIG. 2, the plate 236 is disposed on an outer surface 239 of the press zone 234 far away from the elastic member 220. Namely, the user will contact the plate 236 rather than the press zone 234 of the flexible membrane 232 when pressing the key structure 200. In the present embodiment, the key structure 200 provides a harder touch feedback when the presses the key structure 200 and contacts the harder plate 236, so as to meet diverse requirements.

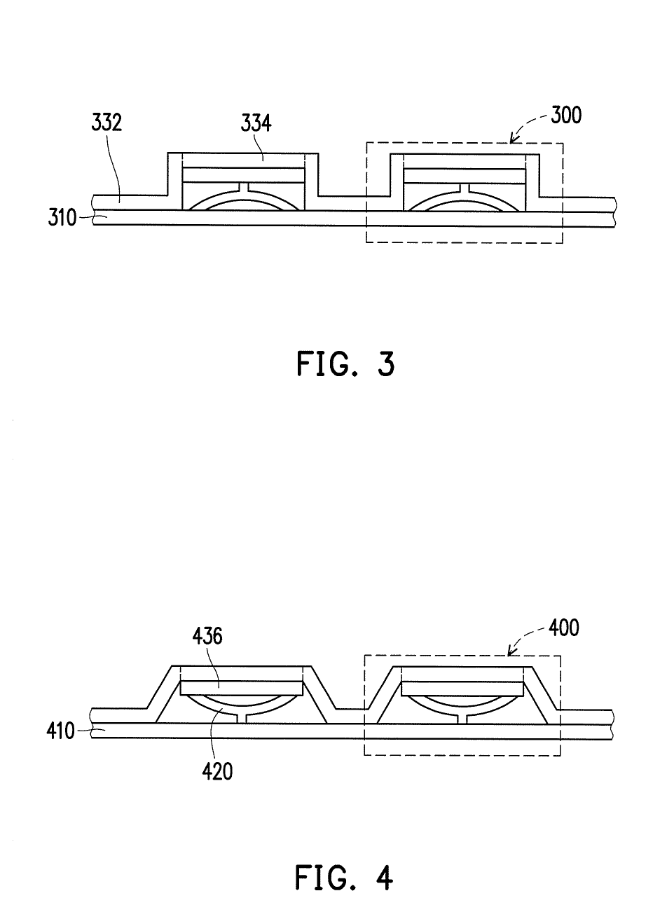

FIG. 3 is a partial schematic view of a keyboard module according to another embodiment of the present invention. Referring to FIG. 3, main difference between the key structure 300 of FIG. 3 and the key structure 100 of FIG. 1 lies in different profiles between the flexible membranes 132 and 332. More specifically, in FIG. 1, the area in the periphery of the press zone 134 of the flexible membrane 132 and the area of the flexible membrane 132 being connected to the switch circuit 110 together foam an angle smaller than 90 degrees. In FIG. 3, the area in the periphery of the press zone 334 of the flexible membrane 332 and the area of the flexible membrane 332 being connected to the switch circuit 310 together form an angle about 90 degrees.

When the angle between the area in the periphery of the press zone 334 of the flexible membrane 332 and the area of the flexible membrane 332 becomes 90 degrees, a greater force applied by the user is required. Therefore, designers may adjust the aforementioned angle according to their requirements, to provide desirable touch feedback.

FIG. 4 is a partial schematic view of a keyboard module according to another embodiment of the present invention. Referring to FIG. 4, main difference between the key structure 400 of FIG. 4 and the key structure 100 of FIG. 1 lies in variation of profiles of the elastic members 120 and 420 along a direction from the plates 136 and 436 toward the switch circuit 110 and 410. In FIG. 1, a width of the elastic member 120 is gradually increased along the direction from the plate 136 toward the switch circuit 110. In FIG. 4, a width of the elastic member 420 is gradually decreased along the direction from the plate 436 toward the switch circuit 410. However, no matter what variation the profile of the elastic member 420 in the direction from the plate 436 toward the switch circuit 410 is, the key structure 400 falls within the scope of the invention as long as the key structure 400 can successfully trigger the switch circuit 410 when being pressed downward.

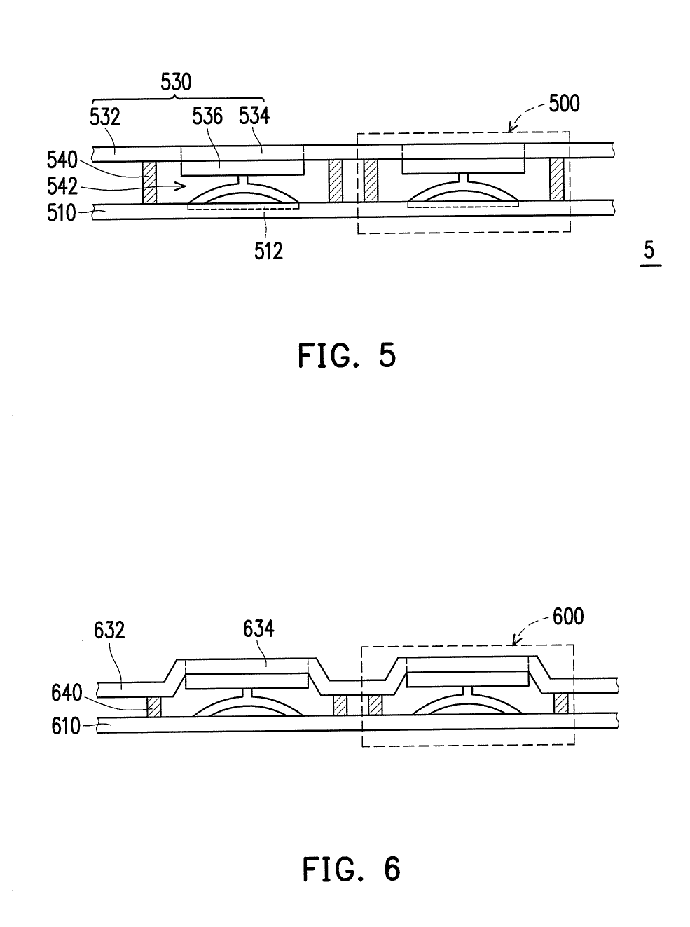

FIG. 5 is a partial schematic view of a keyboard module according to another embodiment of the present invention. Referring to FIG. 5, main difference between the keyboard module 5 of FIG. 5 and the keyboard module 1 of FIG. 1 lies in that: the keyboard module 5 further includes a frame 540. The frame 540 is disposed between the switch circuit 510 and the flexible membrane 532, and the frame 540 has multiple openings 542 corresponding to the key structures 500. Part of the height of the frame 540 offers a sufficient stroke of the press unit 530 or increases a whole height of the press unit 530. In fabrication, the frame 540 and the press unit 530 can be fixed with each other after they are manufactured individually, or the frame 540 and the press unit 530 can be integrally formed with each other.

In the present embodiment, the frame 540 supports and located between the switch circuit 510 and the flexible membrane 532, wherein the openings 542 are respectively corresponding to the predetermined press areas 512 of the switch circuits 510 and the press zones 534 of the flexible membrane 532, and the elastic members 520 and plates 534 of the key structures 500 are located in their corresponding openings 542. The press zones 534 and the plates 536 move toward the frame 540 when being pressed. That is, the frame 540 is separated from the plates 536, and the frame 540 and the plates 536 are not interfered with each other. Furthermore, in the present embodiment, the flexible membrane 532 is flat, and a distance between each of the press zones 534 and the switch circuit 510 is equal to the height of the frame 540.

FIG. 6 is a partial schematic view of a keyboard module according to another embodiment of the present invention. Referring to FIG. 6, main difference between the key structure 600 of FIG. 6 and the key structure 500 of FIG. 5 lies in that: the flexible membrane 632 has a lumpy profile, and the frame 640 contacts a part of the flexible membrane 632 outside the press zone 634. Since the press zone 634 protrude with respect to the remaining part of the flexible membrane 632, a distance between the press zone 634 and the switch circuit 610 is greater than the height of the frame 640.

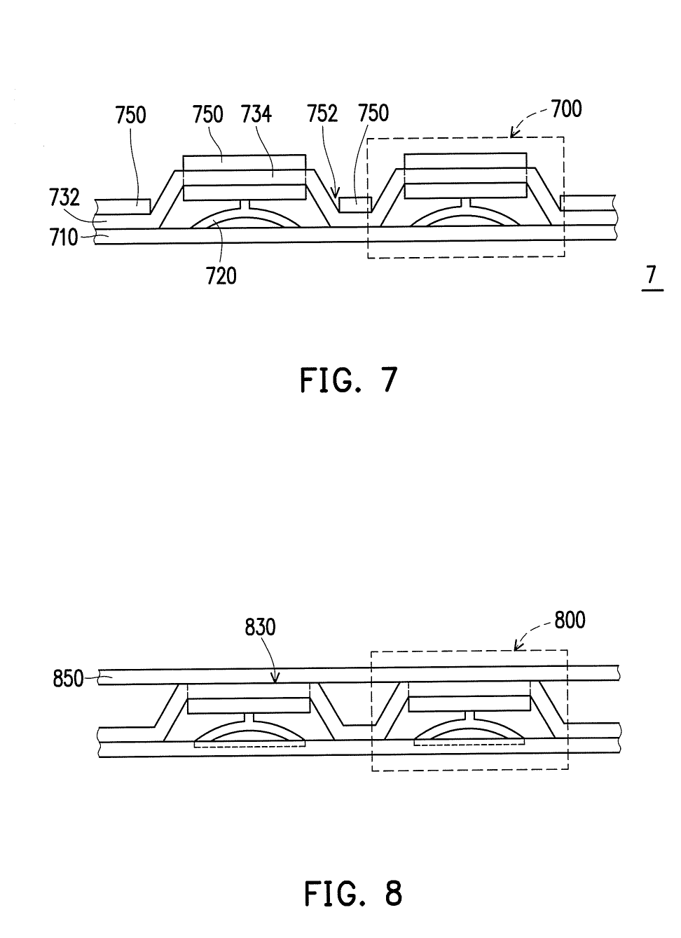

FIG. 7 is a partial schematic view of a keyboard module according to another embodiment of the present invention. Referring to FIG. 7, main difference between the keyboard module 7 of FIG. 7 and the keyboard module 1 of FIG. 1 lies in that: the keyboard module 7 of FIG. 7 further includes a decoration layer 750 disposed on at least a part of the membrane 732. Part of the decoration layer 750 has openings 752

In the present embodiment, the decoration layer 750 is located on the press zone 734 and on the regions where the flexible membrane 732 connects the switch circuit 710 and the elastic member 720. The decoration layer 750 on the press zone 734 may include multiple signs, such as icons, symbols, characters, or numbers. In addition, the decoration layer 750 on the press zone 734 may further include multiple bumps, such that users can determine the position where their fingers touch through the bumps. The decoration layer 750 in the press zone 734 is located above the elastic member 720. Furthermore, the decoration layer 750 located on the regions where the flexible membrane 732 connects the switch circuit 710 can improve the aesthetic of appearance.

FIG. 8 is a partial schematic view of a keyboard module according to another embodiment of the present invention. Referring to FIG. 8, main difference between the key structure 800 of FIG. 8 and the key structure 700 of FIG. 7 lies in that: part of the decoration layer 750 in FIG. 7 has openings 752. In FIG. 8, the decoration layer 850 is a complete layer without openings. In the present embodiment, material of the decoration layer 850 may be soft material, such as leather. Accordingly, the decoration layer 850 without openings can deform with the movement of the press unit 830 when being pressed.

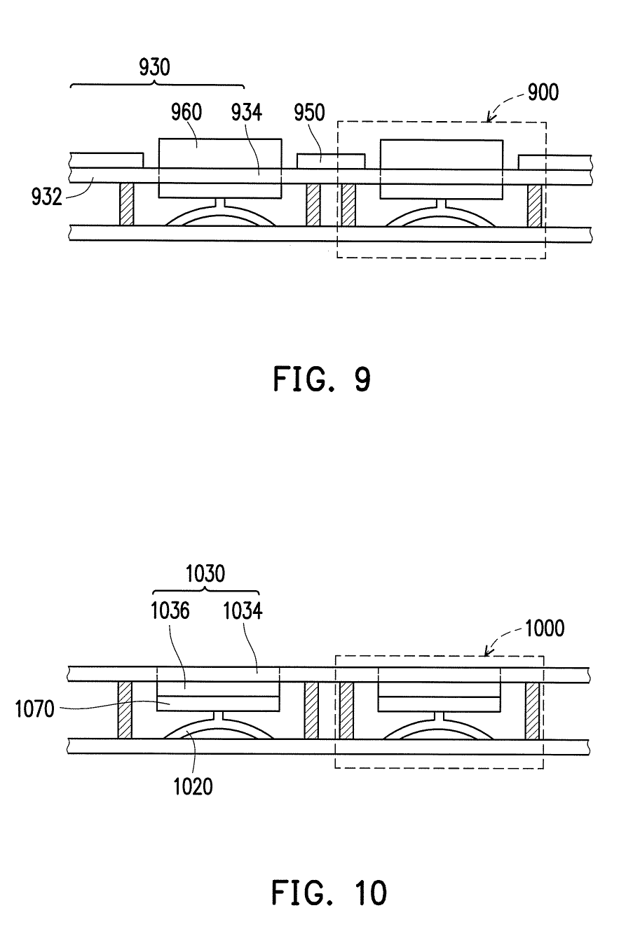

FIG. 9 is a partial schematic view of a keyboard module according to another embodiment of the present invention. Referring to FIG. 9, main difference between the key structure 900 of FIG. 9 and the key structure 500 of FIG. 5 lies in that: the key structure 900 of FIG. 9 further includes a key cap 960 and a decoration layer 950. The key cap 960 covers the press zone 934, and the decoration layer 950 is located between two key caps 960. The key cap 960 assists a user in determining the position of the press zone 934 of the press unit 930, while the decoration layer 950 improves the aesthetic of appearance. Certainly, color or height of the key cap 960 can be adjusted to meet diverse requirements of appearance. It is noted that the key cap 960 may further be applied in the key structure 100 having the lumpy flexible membrane 132 of FIG. 1, and is not limited to the key structure 900 having the flat flexible membrane 932.

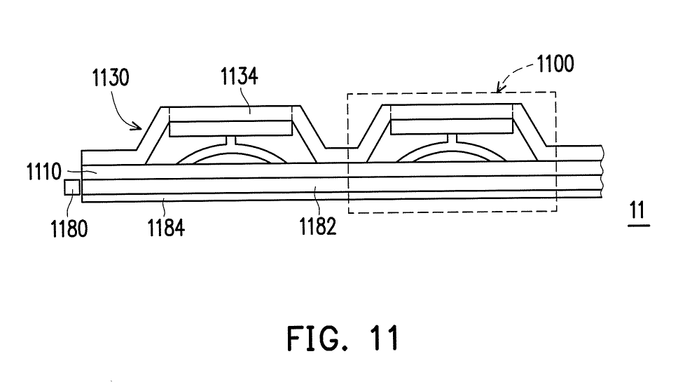

FIG. 10 is a partial schematic view of a keyboard module according to another embodiment of the present invention. Referring to FIG. 10, main difference between the key structure 1000 of FIG. 10 and the key structure 500 of FIG. 5 lies in that: the key structure 1000 of FIG. 10 further includes a touch sensing unit 1070, disposed between the elastic member 1020 and the press unit 1030. More specifically, in the present embodiment, the touch sensing unit 1070 is a printed sensing circuitry formed on a flexible circuit board and disposed between the elastic member 1020 and the plate 1036. However, types or position of the touch sensing unit 1070 is not limited to those mentioned above. Any capacitive sensing device is applicable and can be disposed on an effective position where such device can react when a finger of a user contact or suspend above the press zone 1034.

FIG. 11 is a partial schematic view of a keyboard module according to another embodiment of the present invention. Referring to FIG. 11, main difference between the keyboard module 11 of FIG. 11 and the keyboard module 1 of FIG. 1 lies in that: the keyboard module 11 of FIG. 11 further includes a light emitting device 1180, a light guiding layer 1182, and a reflective layer 1184. In other words, the keyboard module 11 can emit light.

In the present embodiment, the light emitting device 1180 may comprise a light emitting diode, but the present invention is not limited thereto. The light guiding layer 1182 has a surface disposed at a side of the switch circuit 1110 and another surface disposed at a side of the light emitting device 1180. As shown in FIG. 11, the switch circuit 1110 is disposed on the upper surface of the light guiding layer 1182, and the light emitting device 1180 is disposed at the side surface of the light guiding layer 1182. The reflective layer 1184 is disposed at the lower surface of the light guiding layer 1182.

In the present embodiment, a part of the press zone 1134 of the key structure 1100 is light transmissive, and the switch circuit 1110 is a light transmissive conductive film. Therefore, a part of light emitted from the light emitting device 1180 directly passes through the light guiding layer 1182 and the switch circuit 1110, and then outputted from the press zone 1134. And, another part of the light emitted may be reflected by the reflective layer 1184 first, then passing through the light guiding layer 1182 and the switch circuit 1110, and outputted from the press zone 1134. In other embodiments, the switch circuit 1110 may comprise at least a through hole (not shown), and the light transmitted in the light guiding layer 1182 can pass through the through hole and then emitted to the press zone 1134.

It is noted that, to a conventional X-type key structure, a metallic member are required between the switch circuit and the press unit to fix the X-type key structure, and a part of the light is blocked by the metallic member which reduces the intensity of light emitted out of the key structure. In the present embodiment, no fixing structure (e.g., the metallic member) is required between the switch circuit 1110 and the press unit 1130, so as to achieve a higher light emitting efficiency.

It is noted that, in the present embodiment, the light emitting device 1180, the light guiding layer 1182 and the light reflective layer 1184 can be applied not only to the keyboard module 1 of FIG. 1 for forming the keyboard module 11 of FIG. 11, but also to any of the keyboard modules mentioned in the above embodiments, and are not limited to the figures.

In summary, the key structure and the keyboard module of the invention are provided by fixing the plate to the press zone of the flexible membrane. By which, when one corner of one of the press zones is pressed, a corner of the plate fixed with the press zone moves downward accordingly while an opposite corner of the plate is limited by the flexible membrane from moving upward. Instead, the opposite corner of the plate is moved downwardly by the reactive force from the flexible membrane, such that the whole plate and the whole press zone move downwardly together to press the elastic member uniformly and trigger the switch circuit. In other words, forsaking the conventional X-type key structure, the key structure and the keyboard module of the invention are provided by fixing the plate to the press zone of the flexible membrane to accomplish vertical movement in operation. Accordingly, the key structure and the keyboard module of the invention have not only simple structure and low cost, but also thinner thickness to meet the requirement of slimness.

Although the invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A key structure, comprising:
a switch circuit, comprising a predetermined press area;
an elastic member, disposed on the predetermined press area of the switch circuit; and
a press unit, disposed on the elastic member and includes a flexible membrane and a plate, wherein a part of the flexible membrane forms a press zone corresponding to the plate, a position of the press zone is corresponding to a position of the elastic member, and the plate is fixed with the press zone,
wherein as one corner of the press zone is pressed, a corner of the plate moves downward accordingly while an opposite corner of the plate is limited by the flexible membrane from moving upward, such that the whole plate and the whole press zone move downward together to press the elastic member uniformly and trigger the switch circuit.

2. The key structure of claim 1, wherein the plate is disposed on an inner surface of the press zone facing the elastic member.

3. The key structure of claim 1, wherein the plate is disposed on an outer surface of the press zone far away from the elastic member.

4. The key structure of claim 1, wherein the flexible membrane has a lumpy profile, and a distance between the press zone and the switch circuit is greater than a distance between a remaining part of the flexible membrane and the switch circuit.

5. The key structure of claim 1, further comprising:
a frame, disposed between the switch circuit and the flexible membrane, and having an opening, wherein the elastic member is located in the opening, and the frame is separated from the plate.

6. The key structure of claim 5, wherein the flexible membrane is flat, and a distance between the press zone and the switch circuit is equal to a height of the frame.

7. The key structure of claim 5, wherein the flexible membrane has a lumpy profile, and a distance between the press zone and the switch circuit is greater than a height of the frame.

8. The key structure of claim 1, further comprising:
a decoration layer, disposed on at least a part of the flexible membrane.

9. The key structure of claim 1, further comprising:
a key cap, covering the press zone.

10. The key structure of claim 1, wherein the flexible membrane is integrally formed with the plate.

11. The key structure of claim 1, wherein a width of the elastic member is gradually decreased along a direction from the plate toward the switch circuit.

12. The key structure of claim 1, wherein a width of the elastic member is gradually increased along a direction from the plate toward the switch circuit.

13. The key structure of claim 1, further comprising:
a light emitting device;
a light guiding layer, having a surface disposed at a side of the switch circuit and another surface disposed at a side of the light emitting device; and
a reflective layer, wherein the light guiding layer is disposed between the switch circuit and the reflective layer, a part of the press zone is light transmissive, and a light emitted from the light emitting device passes through the light guiding layer and the switch circuit, and then outputted from the press zone.

14. The key structure of claim 13, wherein the switch circuit comprises a light transmissive conductive film or at least a through hole.

15. The key structure of claim 1, further comprising:
a touch sensing unit, disposed between the elastic member and the press unit.

16. A keyboard module, comprising:
a switch circuit, comprising a plurality of predetermined press areas;
A plurality of elastic members, respectively disposed on the predetermined press areas of the switch circuit; and
a plurality of press units, respectively disposed on the elastic members, and the plurality of press units comprises a flexible membrane and a plurality of plates, wherein the flexible membrane comprises a plurality of press zones corresponding to the plates, positions of the press zones are respectively corresponding to positions of the elastic members, and the plates are respectively fixed with the press zones,
wherein as one corner of one of the press zones is pressed, a corner of the plate fixed with the press zone moves downward accordingly while an opposite corner of the plate is limited by the flexible membrane from moving upward, such that the whole plate and the whole press zone move downward together to press the corresponding elastic member uniformly and trigger the corresponding switch circuit.

17. The keyboard module of claim 16, wherein each of the plates is disposed on an inner surface of the corresponding press zone facing the elastic member.

18. The keyboard module of claim 16, wherein each of the plates is disposed on an outer surface of the corresponding press zone far away from the elastic member.

19. The keyboard module of claim 16, wherein the flexible membrane has a lumpy profile, and a distance between each of the press zones and the switch circuit is greater than a distance between a remaining part of the flexible membrane and the switch circuit.

20. The keyboard module of claim 16, further comprising:
a frame, disposed between the switch circuit and the flexible membrane, and having a plurality of openings, wherein the elastic members are respectively located in the openings, and the frame is separated from the plates.

21. The keyboard module of claim 20, wherein the flexible membrane is flat, and a distance between each of the press zones and the switch circuit is equal to a height of the frame.

22. The keyboard module of claim 20, wherein the flexible membrane has a lumpy profile, and a distance between each of the press zones and the switch circuit is greater than a height of the frame.

23. The keyboard module of claim 16, further comprising:
a decoration layer, disposed on at least a part of the flexible membrane.

24. The keyboard module of claim 16, further comprising:
a plurality of key caps, respectively covering the press zones.

25. The keyboard module of claim 16, wherein the flexible membrane is integrally formed with the plates.

26. The keyboard module of claim 16, wherein a width of each of the elastic members is gradually decreased along a direction from the corresponding plate toward the switch circuit.

27. The keyboard module of claim 16, wherein a width of each of the elastic members is gradually increased along a direction from the corresponding plate toward the switch circuit.

28. The keyboard module of claim 16, further comprising:
a light emitting device;
a light guiding layer, having a surface disposed at a side of the switch circuit and another surface disposed at a side of the light emitting device; and
a reflective layer, wherein the light guiding layer is disposed between the switch circuit and the reflective layer, a part of each of the press zones is light transmissive, and a light emitted from the light emitting device passes through the light guiding layer and the switch circuit, and then outputted from the press zones.

29. The keyboard module of claim 28, wherein the switch circuit comprises a light transmissive conductive film or a plurality of through holes.

30. The keyboard module of claim 16, further comprising:
a plurality of touch sensing units, respectively disposed between the elastic members and the press units.
